(19) United States
(12) Patent Application Publication
(10) Pub. No.: US 2012/0075629 A1
(43) Pub. Date: Mar. 29, 2012

(54) PARTICLE ANALYSIS FOR CORROSION RATE MONITORING

(75) Inventors: Omar Jesus YEPEZ, Owasso, OK (US); Ricky Eugene SNELLING, Tulsa, OK (US)

(73) Assignee: CONOCOPHILLIPS COMPANY, Houston, TX (US)

(21) Appl. No.: 13/214,480

(22) Filed: Aug. 22, 2011

Related U.S. Application Data
(60) Provisional application No. 61/386,854, filed on Sep. 27, 2010.

(51) Int. Cl. G01N 15/02; G01N 15/00

(52) U.S. Cl. 356/336; 73/865.5

(57) ABSTRACT

Methods and apparatus relate to measuring corrosion rate. Corrosive fluid contacts a metal powder altering physical properties of the metal powder due to resulting corrosion thereof. For example, the corrosion diminishes mass of the metal powder reducing particle size and particle surface area of the metal powder. Since these physical properties of the metal powder are indicative of the corrosion rate, analysis of the metal powder provides the corrosion rate based on difference in the property of the metal powder before and after the contact with the corrosive fluid.

### CROSS-REFERENCE TO RELATED APPLICATIONS

This application is a non-provisional application which claims benefit under 35 USC §119(e) to U.S. Provisional Application Ser. No. 61/386,854 filed Sep. 27, 2010, entitled “PARTICLE ANALYSIS FOR CORROSION RATE MONITORING,” which is incorporated herein in its entirety.

### STATEMENT REGARDING FEDERALLY SPONSORED RESEARCH OR DEVELOPMENT

None

### FIELD OF THE INVENTION

Embodiments of the invention relate to methods and systems for corrosion rate monitoring based on particle analysis.

### BACKGROUND OF THE INVENTION

Various applications benefit from knowledge regarding corrosiveness of certain fluids on particular metals. Experiments can test to determine such corrosion rates. By way of example, the corrosion rates facilitate selecting which oils to accept for processing in refineries, evaluating corrosion inhibiting additives, and scheduling replacement for components that are susceptible to corrosion.

Gravimetric analysis of a metal coupon placed in contact with the fluid provides one past experimentation technique used to determine the corrosion rates. However, weight differences before and after a test run may represent about one percent, or even less, of an initial weight of the coupon introducing potential for errors with such direct weight measurements. The gravimetric analysis of the coupon often require undesirable test run times lasting several days since quicker test run times given limited surface area of the coupon fail to provide the weight difference that is necessary.

Another prior approach for determining the corrosion rate measures concentration of corrosion products in a fluid that contacts material being corroded. These measurements of the fluid rely on solubility of the products in the fluid. Analysis of the fluid as a measure of the corrosion rate may thus not provide appropriate correlations to the corrosion rate in some applications.

Therefore, a need exists for improved methods and systems for corrosion rate monitoring.

### BRIEF SUMMARY OF THE DISCLOSURE

In one embodiment, a method of monitoring corrosion rate includes contacting a metal powder with a corrosive liquid. The metal powder has an average particle size less than 100 microns. The method further includes measuring a property of the metal powder to provide a measurement taken after the contacting of the metal powder with the corrosive liquid and determining the corrosion rate of the metal powder within the corrosive liquid based on a difference between the measurement and an initial value for the property before the contacting of the metal powder with the corrosive liquid.

According to one embodiment, a method of monitoring corrosion rate includes contacting a metal powder with a corrosive liquid. In addition, the method includes measuring particle sizes of the metal powder by light diffraction analysis after the contacting of the metal powder with the corrosive liquid. Determining the corrosion rate of the metal powder within the corrosive liquid utilizes an initial value for the particle sizes and a measurement obtained by the measuring of the particle sizes to assess change of the metal powder caused by corrosion.

For one embodiment, a method of monitoring corrosion rate includes contacting a metal powder with a corrosive liquid. Analyzing the metal powder contacted with the corrosive liquid provides a measurement for surface area of the metal powder obtained as a function of particle size distribution. Determining the corrosion rate of the metal powder within the corrosive liquid utilizes an initial value for the surface area before the contacting of the metal powder with the corrosive liquid and the measurement of the surface area.

### BRIEF DESCRIPTION OF THE DRAWINGS

A more complete understanding of the present invention and benefits thereof may be acquired by referring to the following description taken in conjunction with the accompanying drawings.

FIG. 1 is a flow chart illustrating a method of monitoring corrosion rate based on a property difference in a metal powder before and after contact with a corrosive fluid, according to one embodiment of the invention.

FIG. 2 is a graph of analytical results illustrating variation of surface area versus temperature of corrosive tests for oleic acid in mineral oil compared to a crude oil sample, according to one embodiment of the invention.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

Embodiments of the invention relate to methods and systems for measuring corrosion rate. Corrosive fluid contacts a metal powder altering physical properties of the metal powder due to resulting corrosion thereof. For example, the corrosion diminishes mass of the metal powder reducing particle size and/or particle surface area of the metal powder. Since these physical properties of the metal powder are indicative of the corrosion rate, analysis of the metal powder provides the corrosion rate based on difference in the property of the metal powder before and after the contact with the corrosive fluid. For some embodiments, the corrosion rate enables selection of oils to accept for processing in a refinery, evaluation of a corrosion inhibiting additive, or determination of criteria, such as material type or replacement timing, for components susceptible to corrosion.

In some embodiments, at least one of iron, manganese, molybdenum and nickel provide metal content within the metal powder. Elemental metals or compounds containing metals may form the metal powder. Selection of the particle size for the metal powder before contact with the corrosive liquid depends on several factors. The particle size can influence detection of the difference in the property of the metal powder and/or duration of corrosion testing. Selection of the metal powders with the initial particle size as small as possible thus avoids corrosion testing that lasts longer than desired. In some embodiments, total contact time between the metal powder and the corrosive liquid is less than two hours. For example, a set duration of the corrosion testing may provide a certain reduction in particle size, which represents a percentage change that increases as the particle size decreases thus facilitating detection. However, the reduction in particle size may result in total dissolution of some particles limiting usefulness of particle size distribution differences to determine corrosion rates even though the surface area and the particle size distribution are otherwise expected to change together. Therefore, the metal powder for some embodiments may have an initial average particle size less than 100 microns or between about 5 microns and about 10 microns in diameter.

Corrosiveness of the liquid that is contacted with the metal powder may come from acids or bases within the liquid. A mixture of hydrocarbons and naphthenic acids provides an example of the liquid contacted with the metal powder. For example, the naphthenic acids may react with the iron within the metal powder if made from carbon steel.

For some embodiments, the corrosion testing includes loading the metal powder into a reactor along with the corrosive liquid. The metal powder and the corrosive liquid then react for a selected duration in a batch process within the reactor that may be maintained with processing parameters that may vary to simulate anticipated conditions of particular applications in which the metal and/or liquid are to be used. In some embodiments, the corrosive liquid may pass through the reactor and in contact with metal powder during the testing. The processing parameters may include flow rate for passing the liquid through the reactor, constituents of the liquid, total acid number (TAN) of the liquid, rotation speed of a stirrer in the reactor, pressure of the liquid in the reactor, and temperature of the liquid in the reactor. For example, the temperature and the pressure may range from about 150° C. to about 350° C. and about 1000 kilopascal (kPa) to about 3500 kPa.

Following reaction of the metal powder with the corrosive liquid, analysis of the metal powder determines the property that changed as a result of the reaction. Exemplary analytical techniques suitable for analyzing the metal powder include laser diffraction, sedimentation, or electrozone sensing. Techniques utilizing the laser diffraction enable particle sizing given that a suspension containing the metal powder in a path of light scatters the light at an angle related to particle size. Such particle sizing methods enable measuring particle size distributions, average particle size and surface area of the metal powder obtained as a function of particle size distribution.

In some embodiments, isolating of the metal powder facilitates the analysis of the metal powder and includes separating or filtering to remove the metal powder from the corrosive liquid and washing of the metal powder to remove any residue of the corrosive liquid. Drying of the metal powder vaporizes fluid used in the washing leaving the metal powder. Next, addition of a dispersing medium to the metal powder forms a suspension that is suitable for performing the analysis of the metal powder.

Amount of reduction in the surface area or the radius as measured and taking into account duration of the contact between the metal powder and the corrosive liquid enables determining the corrosion rate. Such calculations may rely on overall differentials or specific differentials, such as differences in average particle size. Initial values for the property of the metal powder may be known (e.g., from supplier product descriptions) or likewise measured prior to the corrosion testing. In some embodiments, the calculation provides the corrosion rate with units of dimension per period of time.

By way of example, the calculation of the corrosion rate of the metal powder may derive from difference in the average particle size of the metal powder before and after the contact between the metal powder and the corrosive liquid as follows. Reduction in the average particle size corresponds to loss of material from a single theoretical particle due to the corrosion. Calculating volume (V) of the material dissolved or lost thus includes solving an equation given by:

$$V = \frac{4}{3} π ( {R}^{3} - {r}^{3} ) ,$$

where R is an initial radius of the average particle size and r is a final radius of the average particle size as measured following the reaction of the metal powder with the corrosive liquid. Multiplying the volume (V) by density (ρ) of the material making up the metal powder provides weight (ΔW) of the material dissolved as defined by:

ΔW=V(ρ).

Rate of corrosion in, for example, mills per year (mpy) may then be solved for according to:

$$mpy = \frac{K ( Δ W )}{ρ ( A ) ( T )} ,$$

where K is a conversion constant, A is initial area of the average particle size, and T is time that the metal powder was exposed to the corrosive liquid.

For some embodiments, calibration of the difference between the measurement and the initial value for the property indicative of surface area to known changes in the surface area for given corrosion rates enables determination of the corrosion rate. In particular, one or more known fluids with known corrosion rates for the metal powder may provide a calibration curve showing corresponding surface area losses. Matching to the calibration curve measured reduction in surface area due to the contact of the metal powder with the corrosive liquids tested determines the corrosion rate thereof.

Sulfur content in the corrosive liquid may influence testing as described herein. Sulfur species may lead to deposition of scale onto the metal powder and inhibit extent of dissolution of the metal powder. The results may therefore include a compensation factor for amount of the sulfur content in the corrosive liquid.

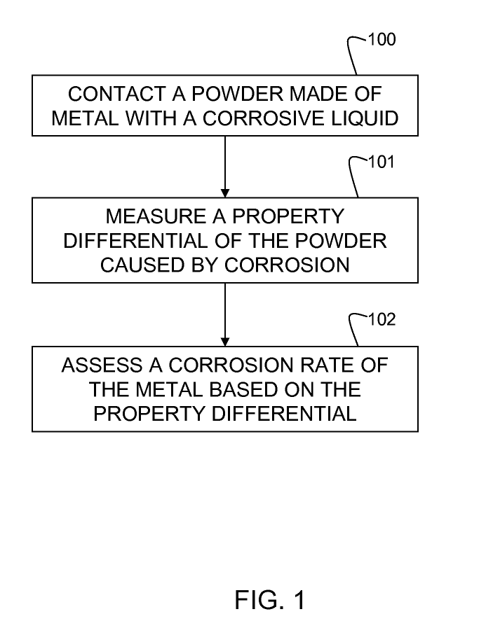

FIG. 1 illustrates a method of monitoring the corrosion rate according to basic actions that may implement any more detailed aspects described herein. In reaction step 100, a corrosive liquid contacts a powder made of metal for an experimental time period. Analysis step 101 performed after completion of the time period includes measuring of a property differential of the powder as a result of corrosion from the contact with the liquid. Next, assessing the corrosion rate of the metal occurs in determination step 102 based on the property differential measured in the analysis step 101.

The following examples of certain embodiments of the invention are given. Each example is provided by way of explanation of the invention, one of many embodiments of the invention, and the following examples should not be read to limit, or define, the scope of the invention.

### Example

A reactor was loaded with 2 grams of iron particles having an average diameter of 1.058 microns and surface area of 0.721 square meters per gram (m²/g). The iron particles were mixed with 20 grams of oleic acid in mineral oil having a total acid number of 10 milligrams KOH per gram (mg KOH/g) added to the reactor and reacted with the iron particles for 18 hours under 200 pounds per square inch (psi) of nitrogen. Thereafter, the iron particles were filtered, washed with toluene and then acetone, and dried in air. The iron particles were next dispersed in isopropanol with resulting slurry analyzed by laser diffraction particle sizing.

Separate runs were conducted at different temperatures from 150° C. to 350° C. for the reaction of the iron powder with the oleic acid in mineral oil. Further tests were run with all aspects repeated except that the oleic acid in mineral oil was replaced with a crude oil sample. The crude oil had a TAN of 0.8 mg KOH/g.

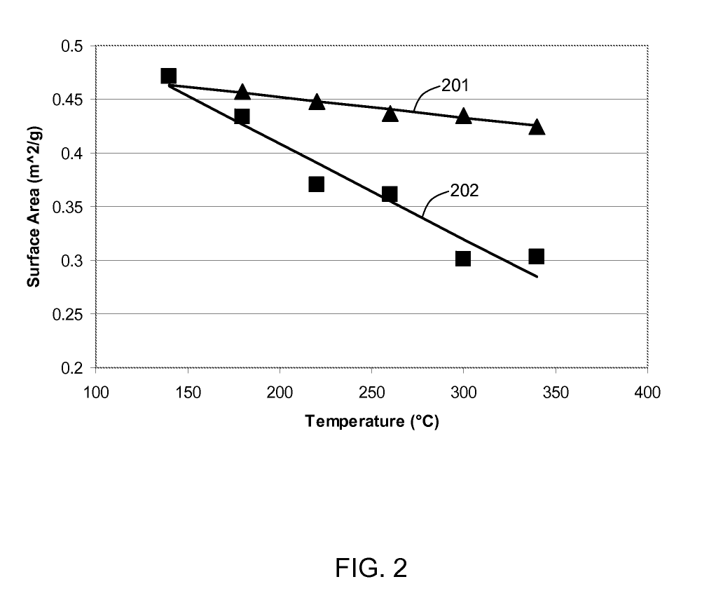

FIG. 2 shows a graph of analytical results illustrating variation of surface area versus temperature of foregoing corrosive test runs for the crude oil sample identified as a first line 201 compared to the oleic acid in mineral oil depicted by a second line 202. The oleic acid in mineral oil resulted in greater reduction in the surface area than the crude oil sample with relative lower TAN. Slopes of the lines 201, 202 correspond to change in the corrosion rate with changing temperature. With correlation coefficients of 0.97 and 0.94, the lines 201, 202 fit to actual data points shown on the graph demonstrated linear relationship between reduction in the surface area and temperature sensitivity of the corrosion rate. Comparison of these slopes showed that the crude oil was 4.5 times less sensitive to temperature change than the oleic acid in mineral oil. Such surface area data corresponded with expected differences in the corrosion rates based on the TAN and/or the temperature thus showing that the corrosion rate may be determined using any one particular data point representing differential surface area (e.g., from 0.721 m²/g to 0.435 m²/g for the test run of the crude oil sample at 300° C.) before and after the reaction. Further, differential between two data points at any particular temperature for each of the crude oil sample and the oleic acid in mineral oil represents ability to measure differences in the corrosion rates or make comparisons to a standard or solution of known corrosiveness and/or composition.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A method, comprising:
contacting a metal powder with a corrosive liquid, wherein the metal powder has an average particle size less than 100 microns;
measuring a property of the metal powder to provide a measurement taken after the contacting of the metal powder with the corrosive liquid; and
determining a corrosion rate of the metal powder within the corrosive liquid based on a difference between the measurement and an initial value for the property before the contacting of the metal powder with the corrosive liquid.

2. The method according to claim 1, wherein the property is surface area of the metal powder.

3. The method according to claim 1, wherein the property is particle size distribution of the metal powder.

4. The method according to claim 1, wherein the determining of the corrosion rate is based on time of the contacting, surface area calculated from the property that is indicative of particle size, and weight change calculated using density of material forming the powder and change in the particle size determined from the difference in the measurement and the initial value.

5. The method according to claim 1, wherein the corrosive liquid includes naphthenic acid.

6. The method according to claim 1, wherein the metal powder includes iron.

7. The method according to claim 1, wherein the metal powder is made of iron and the corrosive liquid is a hydrocarbon containing naphthenic acid.

8. The method according to claim 1, wherein the metal powder has an average particle size between 5 and 10 microns.

9. The method according to claim 1, wherein the determining of the corrosion rate includes calibration of the difference between the measurement and the initial value for the property indicative of surface area to known changes in the surface area for given corrosion rates.

10. The method according to claim 1, wherein the measuring of the property includes analysis of light scattering through a suspension containing the metal powder.

11. The method according to claim 1, further comprising filtering, rinsing and drying the metal powder after the contacting of the metal powder with the corrosive liquid and then mixing the metal powder in a dispersing medium for measuring of the property.

12. The method according to claim 1, further comprising disposing the metal powder within a heated interior of an autoclave where the metal powder during the contacting is exposed to the corrosive liquid above ambient pressure.

13. The method according to claim 1, wherein total contact time between the metal powder and the corrosive liquid is less than two hours.

14. A method, comprising:
contacting a metal powder with a corrosive liquid;
measuring particle sizes of the metal powder by light diffraction analysis after the contacting of the metal powder with the corrosive liquid; and
determining a corrosion rate of the metal powder within the corrosive liquid utilizing an initial value for the particle sizes and a measurement obtained by the measuring of the particle sizes to assess change of the metal powder caused by corrosion.

15. The method according to claim 14, wherein the change of the metal powder caused by corrosion is surface area reduction.

16. The method according to claim 14, wherein the change of the metal powder caused by corrosion is reduction in average particle size.

17. The method according to claim 14, wherein the determining of the corrosion rate includes a determination of weight change of the metal powder before and after the contacting and calculated using density of material forming the powder and difference in particle size distribution defined by the measurement and the initial value.

18. A method, comprising:
contacting a metal powder with a corrosive liquid;
analyzing the metal powder contacted with the corrosive liquid to provide a measurement for surface area of the metal powder obtained as a function of particle size distribution; and
determining a corrosion rate of the metal powder within the corrosive liquid utilizing an initial value for the surface area before the contacting of the metal powder with the corrosive liquid and the measurement of the surface area.

19. The method according to claim 18, wherein the analyzing of the metal powder includes analysis of light scattering through a suspension containing the metal powder.

20. The method according to claim 18, wherein the determining of the corrosion rate includes calibration of the difference between the measurement and the initial value for the surface area to known changes in the surface area for given corrosion rates.
